(19) United States
(12) Patent Application Publication
(10) Pub. No.: US 2014/0022768 A1
(43) Pub. Date: Jan. 23, 2014

(54) CHILD NIGHT LIGHT/ CUP HOLDER

(71) Applicant: Marco Gerardo Midence, Tampa, FL (US)

(72) Inventor: Marco Gerardo Midence, Tampa, FL (US)

(21) Appl. No.: 13/555,297

(22) Filed: Jul. 23, 2012

(51) Int. Cl. F21V 33/00; F21V 17/10

(52) U.S. Cl. 362/154

(57) ABSTRACT

A device having a container holder having an intermediate connection device connecting the container holder and an attachment device and an integral centrally located light emitting device at the bottom of the container. A light actuation device integral with the bottom of the container holder. The light activation device is a pressure sensitive switch. The light de-activation device is a light sensitive device. The attachment device is a suction cup or a turn knob and clamp. The holder, connection device and attachment device are made of translucent plastic materials.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

(1) Field of the Invention

Relating to the illumination of containers in a container holder. More specifically relating to the illumination of baby bottles and similar container for toddlers.

(2) Description of the Related Art

US Patent Citations

US Patent 6158870 teaches a nursing baby bottle attachment with (an) entertainment device(s) associated therewith, especially the options of both, or either, chosen jingles of music and randomly flashing lights. Such may be just the music, or the paired music and lights with a micro-switch to turn of the lights alone.

U.S. Pat. No. 5,662,406 teaches a baby bottle having a bottle portion with a first proximal end and a second distal end relative a feeding baby, a nipple portion attached to the bottle portion at the proximal end, a light member for illuminating the bottle attached to the distal end of the bottle portion and an attachment member for attaching the light member to the bottle. The light member includes a light source, a main power switch and a power source, all electrically connected together and mounted within a protective housing. The light member may also include an angle sensitive switch for activating the light source when the bottle is not upright.

US Patent application publication 2008/0043471 night light device that provides low level illumination, which turns on automatically when motion is detected near the device and only if the ambient lighting level is too low. The device operates using battery power and is only activated upon detecting both motion and low ambient light level simultaneously. The device will remain active for a period of thirty seconds unless additional motion is detected, in which case it will remain active for thirty seconds after the last detected motion. Two AA alkaline cells are expected to last for one year at an average of 35 light activations per day, resulting in usability and cost efficiency. The device may also be held in the hand for use as a low-lighting flashlight. illumination with both functions is provided by a single light source, reducing the energy consumption and cost for the user, US Patent application publication 2008/0043471 is hereby incorporated by reference.

### Other Prior Art

### Sylvania DOT-it

There are numerous publicly available sources of material showing battery operated night lights. One in particular is the SYLVANIA DOT-it night light 100 that can stick and re-stick practically anywhere. It is small enough to fit in your pocket; sticks to a variety of surfaces, including fabric, leather, plastic, glass and fiberglass. The DOT-it features a wireless, portable design for use at home or on the go. Its lights 110 will last for years and include 3 replaceable AAA batteries for about 100 hours of bright, white LED light. The DOT-it also has a pressure sensitive switch 120 that is centrally located at the top of the device and is switchable ON and OFF. Also, a battery compartment is found at the back of the device using a screw on door concealing the battery compartment. This compartment has within a battery holder that is made of plastic filler and has a small circuit card making the appropriate connections that make the pressure sensitive switch operable.

### The Brica Drink Pod

The Brica Drink Pod is a publicly sold device 200 that can attach to almost any shape tube, rail or seat; it serves as a holder for liquid containers that are inserted in the holder 240. The Drink Pod is easy to install and remove with a large adjustable turn knob 210 located on one side of the device having the attachment device 220 (clamp) actuated by the turn knob 210. The cup holder 240 has a swiveling arm 230 that attaches to the holder 240 in two points on either side of the holder. None of the prior art teaches how to permit a child to gain easy access to a device during the night.

### BRIEF SUMMARY OF THE INVENTION

A device comprising a container holder having an intermediate connection device connecting the container holder and an attachment device and an integral centrally located light emitting device at the bottom of the container. A light actuation device integral with the bottom of the container holder. The light activation device is a pressure sensitive switch. The light activation device may also have an optional light sensitive device. One option is the attachment device is a suction cup whilst another option is a turn knob and clamp. The holder, connection device and attachment device are made of translucent plastic materials.

A device comprising a container holder having an intermediate connection device connecting the container holder and an attachment device an integral centrally located light emitting device at the bottom of the container and a pressure sensitive light actuation device integral with the bottom of the container holder.

A device comprising a container holder having an intermediate connection device connecting the container holder and an attachment device an integral centrally located light emitting device at the bottom of the container and a light sensitive light actuation device integral with the bottom of the container holder.

### BRIEF DESCRIPTION OF THE SEVERAL VIEWS OF THE DRAWINGS

FIG. 1 illustrates a SYLVANIA DOT-it night light as found in the prior art.

FIG. 2 illustrates a Brica Drink Pod as found in the prior art.

FIG. 3 illustrates a CHILD NIGHT LIGHT/CUP HOLDER as found in the instant embodiment.

FIG. 4 illustrates a circuit for a CHILD NIGHT LIGHT/CUP HOLDER as found in the instant invention.

FIG. 5 illustrates one embodiment having a clamp and turn knob feature with the lights powered by the batteries.

FIG. 6 illustrates one embodiment having a suction cup attachment feature with the lights powered by the batteries.

FIG. 7 illustrates the bottom of the device holder showing a light sensor 360, a battery stored in the battery container, a portion of a swiveling arm 320 and an AC adapter cord.

### DETAILED DESCRIPTION OF THE INVENTION

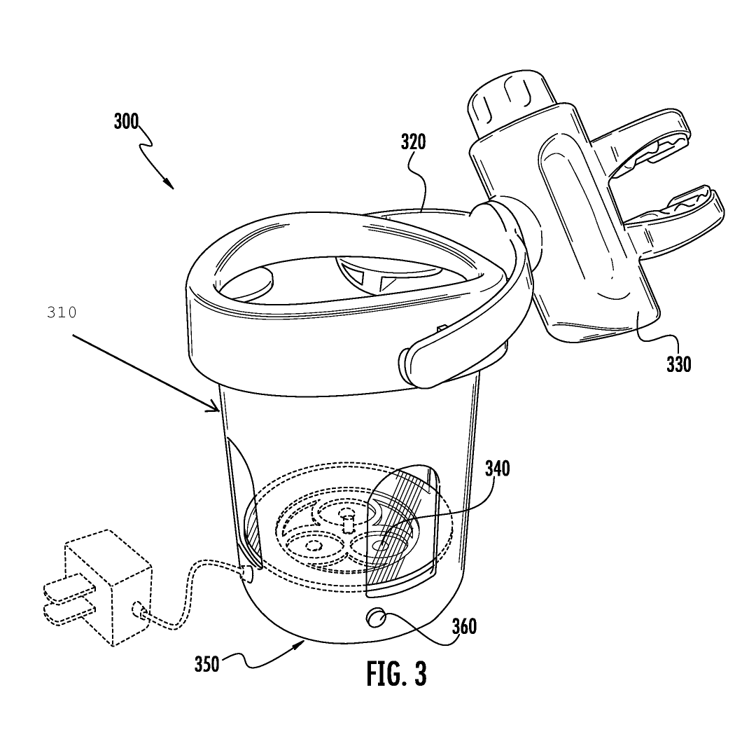

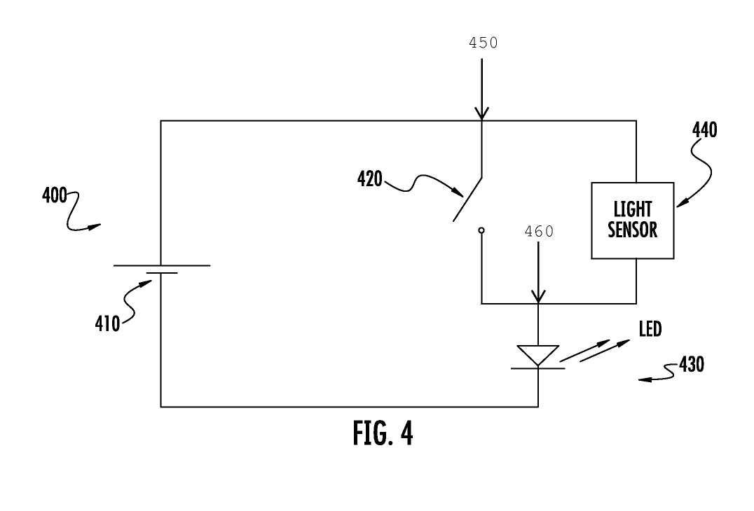

The following discussion of FIGS. 3-4 describe the instant embodiment of the novelty entitled CHILD NIGHT LIGHT/CUP HOLDER.

FIG. 3 illustrates a CHILD NIGHT LIGHT/CUP HOLDER as found in the instant embodiment. The device 300 of the instant embodiment has a container holder 310, an intermediate connection device 320 and an attachment device 330 as well as an integral light generating device 340 at the bottom of the container holder 310. The holder 310, connection device 320 and attachment device 330 are made from plastic materials; these are preferably clear plastic materials so as to permit the light from the light generating device 340 to flow therethrough. An AC adapter is shown in silhouette as an optional feature of the invention whereby it is connected as a power source instead of the batteries. Appropriate connection is made to the internal light circuitry as can be appreciated by the simplicity of the circuitry.

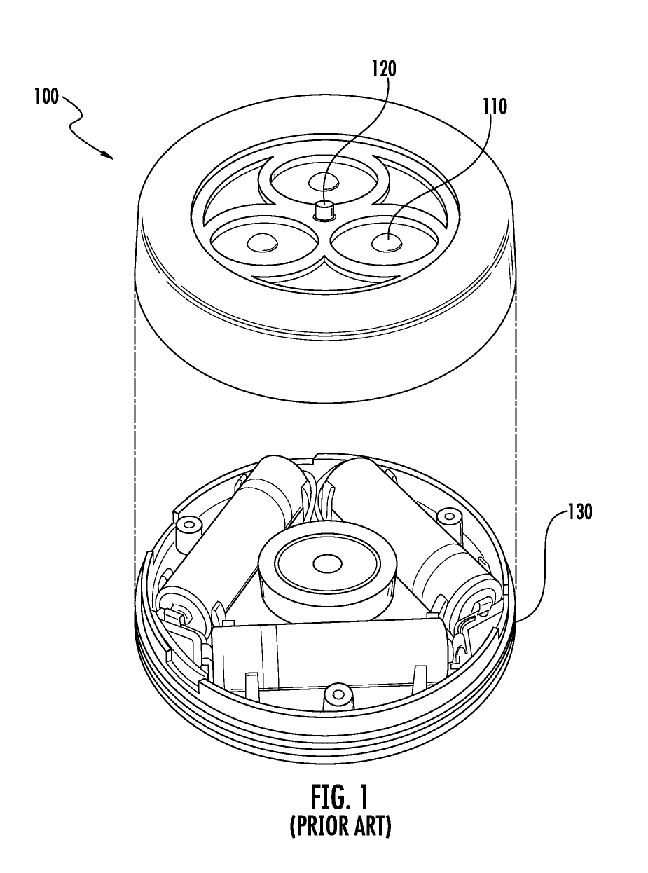

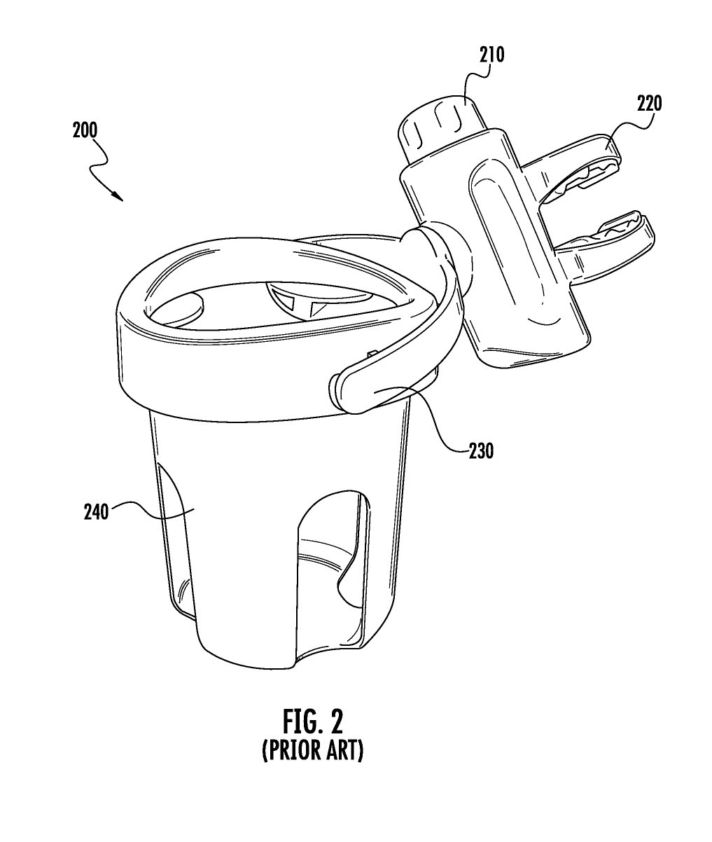

The container holder 310 is designed to fit a typical beverage container or bottle useable by children of different ages; it creates a generally circular empty volume for insertion of the container or bottle and has a bottom portion housing the light generating device 340. The light generating device is essentially the SYLVANIA DOT-it device of FIG. 1 that has been integrated into the bottom of a Brica Drink Pod of FIG. 2. The side walls of the Sylvania DOT-it have been made integral from a single piece of plastic with a Brica Drink Pod type device. Additionally, the screw on battery door 350 that covers a battery compartment is found at the back of the device and is arranged to protrude from the bottom of the holder 310 for easy changing of the batteries. Optionally, a light sensor circuit 360 is arranged within the light generating device 340 within an appropriate cavity through the bottom side wall of the holder 310 and into the plastic filler found therein. This plastic filler material also holds the batteries in place and makes a base from which a circuit can be wired correctly. The parallel connections are made from either battery terminal of the parallel set of batteries through the filler opening cavity and further through the holder 310 wall to the mounted sensor device 360 that can also be heat mounted by using a heat gun to melt the parts in to place. However, it would be best to mechanically mount it using form fitting prongs or protrusions from the inner walls of the cavity that act to hold the sensor in place so as not to damage the sensor circuitry with heat. Alternatively, the cavity in the outer holder can be made small enough so that sensor is unable to exit in that direction.

FIG. 4 illustrates a circuit 400 for a CHILD NIGHT LIGHT/CUP HOLDER as found in the instant invention. A battery source 410 is arranged in parallel with a primary and a secondary circuit that are themselves in series with a set of lights. The first circuit has a pressure sensitive switch 420 and a set of lights 430 that are activated by the appropriate placement of more pressure on the switch changing it to an active or ON state whilst application of less pressure or releasing the switch changes it to an OFF state thereby turning the set of lights off. The secondary circuit is an optional circuit that has a light sensor 440 that activates the lights 430 when there is insufficient lighting and deactivates the lights 430 when there is sufficient lighting. The circuit wiring is arranged within the confines of the light generating device 340 and plastic filler that has appropriate cavities and mounts for the light sensor; typically plastic fitting the form of the particular sensor and used to hold it in place. Also, extra wiring is found to a point 450 from one side of light sensor 440 to before switch 420 and extra wiring is added to a point 460 from the other side of light sensor 440 to before LEDs 430 through the cavities in the plastic filler to and from the light sensor 440.

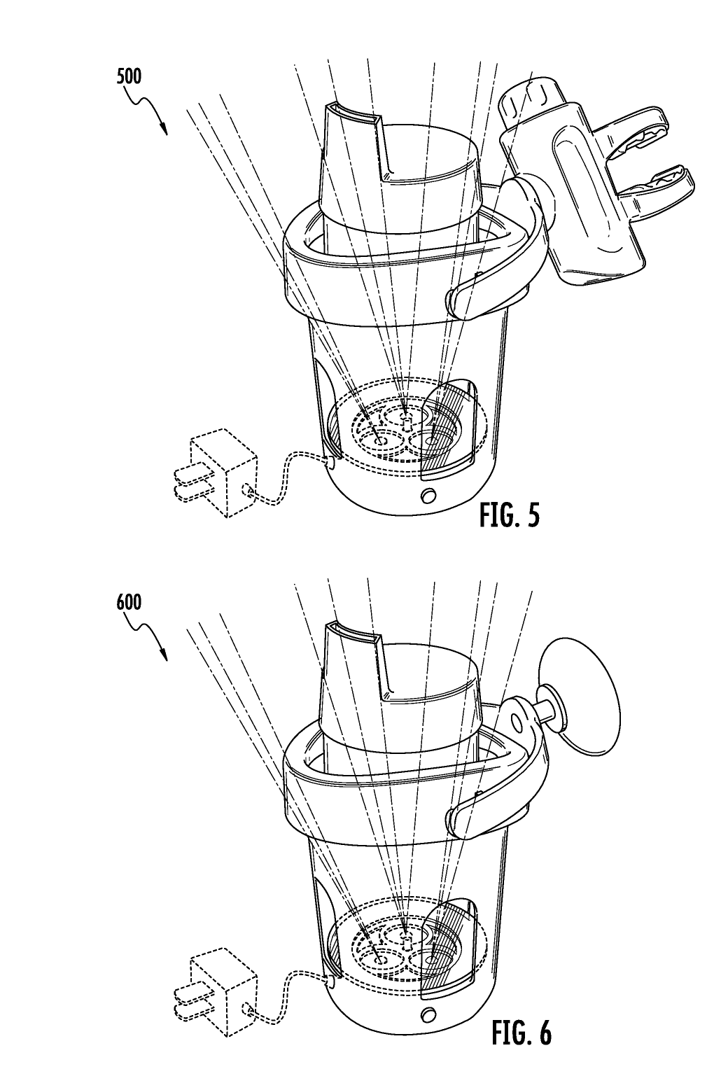

FIG. 5 illustrates one embodiment having a clamp and turn knob feature with the lights powered by the batteries. A light is shown passing from the light source through an inserted container that lights up both holder and container.

FIG. 6 illustrates one embodiment having a suction cup attachment feature with the lights powered by the batteries. The clamp and turn knob feature of FIG. 6 has been replaced with a fixed attachment suction cup. The suction cup has a mount on its underside that fixedly attaches to the swiveling arm 320 of FIG. 3. A light is shown passing from the light source through an inserted container that lights up both holder and container.

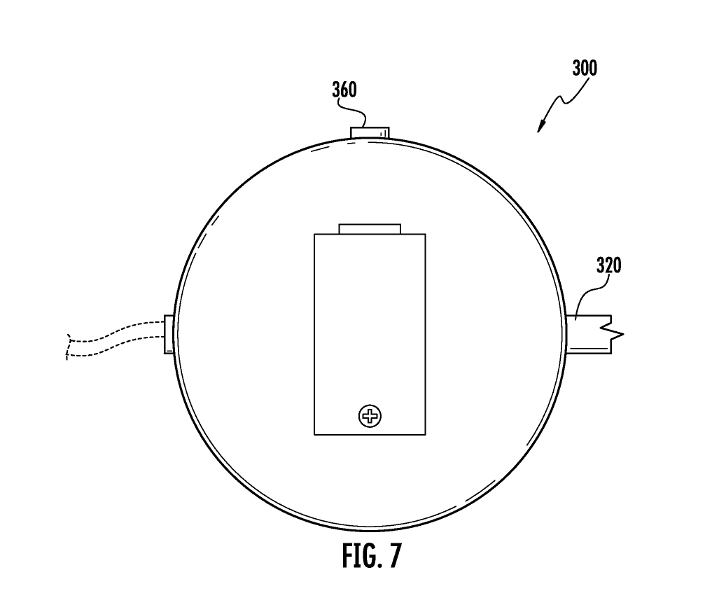

FIG. 7 illustrates the bottom of the device holder showing a light sensor 360, a battery stored in the battery container, a portion of a swiveling arm 320 and an AC adapter cord.

Thus, has been described an improved CHILD NIGHT LIGHT/CUP HOLDER that helps a child locate his drink bottle in the midst of the night or any darkened room when the pressure switch has been activated. Additionally, this device provides a child with the comfort during the night and the convenience of a type of “lighthouse” to guide the child to their drink in darkened rooms.

1. A device comprising:
a container holder having
an intermediate connection device connecting the container holder and
an attachment device and
an integral centrally located light emitting device at the bottom of the container holder.

2. The device of claim 1, further comprising:
a light actuation device integral with the bottom of the container holder.

3. The device of claim 2, wherein the light activation device is a pressure sensitive switch.

4. The device of claim 2, wherein the light activation device is a light sensitive device.

5. The device of claim 1 wherein the attachment device is a suction cup.

6. The device of claim 1 wherein the attachment device is a turn knob and clamp.

7. The device of claim 1, wherein the holder, connection device and attachment device are made of translucent plastic materials.

8. A device comprising:
a container holder having
an intermediate connection device connecting the container holder and
an attachment device
an integral centrally located light emitting device at the bottom of the container holder and
a pressure sensitive light actuation device integral with the bottom of the container holder.

9. A device comprising:
a container holder having
an intermediate connection device connecting the container holder and
an attachment device
an integral centrally located light emitting device at the bottom of the container holder and
a light sensitive light de-actuation device integral with the bottom of the container holder.
